(19) United States
(12) Patent Application Publication
(10) Pub. No.: US 2006/0158995 A1
(43) Pub. Date: Jul. 20, 2006

(54) Optical pickup device and focusing control method of the same

(75) Inventors: Seong-Su Park, Suwon-si (KR); Young-Man Ahn, Suwon-si (KR); Jang-Hoon Yoo, Seoul (KR); Jung-Woo Hong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/250,416

(22) Filed: Oct. 17, 2005

(30) Foreign Application Priority Data
Jan. 17, 2005 (KR) 2005-4329

(51) Int. Cl. G11B 7/00

(52) U.S. Cl. 369/112.03; 369/112.01; 369/44.12

(57) ABSTRACT

An optical pickup device and a focusing control method thereof are provided which can determine a DC offset caused by cross-talk of a focus error signal, eliminate the DC offset based on the determination, correct errors in a focus error signal of a main beam, which is caused by interference of side beams, so that optimal focus tracking can be performed. For this, the optical pickup device has at least one or more light sources, a diffraction optical element which diffracts light from the light source into a plurality of beams, an objective lens which condenses the plurality of beams diffracted by the diffraction optical element, a photo detector which detects the plurality of beams reflected from discs, and an auxiliary photo detector which detects the plurality of beams reflected from the discs to perform error correction of focus error detection signals obtained by the photo detector.

### CROSS-REFERENCE TO RELATED APPLICATIONS

This application claims the benefit of Korean Patent Application No. 2005-4329, filed on Jan. 17, 2005 in the Korean Intellectual Property Office, the entire disclosure of which is hereby incorporated by reference.

### BACKGROUND OF THE INVENTION

1. Field of the Invention

The present invention relates to an optical pickup device. More particularly, the present invention relates to an optical pickup device and a focusing control method to minimize detection errors of focus error signals caused by the interference of side beams.

2. Description of the Related Art

An optical pickup device is installed within an optical recording and/or reproduction apparatus so that it records and/or reproduces information in/from optical information recording media. The optical pickup device also performs detection of focus error signals and tracking of error signals when recording/reproducing information in/from the optical information recording media. Namely, the optical pickup device precisely records/reproduces information in the optical information recording media by focusing servo based detection of focus error signals based on detection of tracking error signals. Therefore, enhanced performance of the optical record/reproduction apparatus depends on how to implement the focusing servo and the tracking servo.

Generally, an optical pickup device includes a light source, an objective lens for condensing a beam from the light source onto a recording surface of an optical information recording medium, and receiving optical elements for detecting information signals and error signals from the beam which is reflected from the optical information recording medium and passed through the objective lens. The optical pickup device implements a focusing servo therein to obtain various shapes of the beams as shown in FIG. 1. The beam shapes are varied according to the servo drive.

The optical pickup device includes a grating which splits a beam from the light source into three beams to record/reproduce optical information in/from optical information recording media such as a CD, a CD-RW, a DVD, and the like. Three photo detectors, as shown in FIGS. 2a and 2b, receive the three split beams. Thus, the three photo detectors detect focus error signals according to beam shapes formed thereon.

Typically, as shown in FIG. 3, when the split three beams of FIG. 2 are received only within a respective corresponding photo detector, there is no DC offset in the signal from the photo detectors.

However, if a part of the side beams received by the side photo detectors 2 and 4 is received by the main photo detector 1, as shown in FIG. 2b, the side beams interfere with the main beam. Particularly, as shown in FIG. 2b, a signal from the main beam will have a DC offset resulting from the amount of cross-talk 5 created by the side beam interference. This causes a focus error signal.

Therefore, if side beam interference occurs, the optical pickup device cannot precisely perform focusing operations due to focus error signals, thereby deteriorating performance of the optical record/reproduction apparatus.

Accordingly, there is a need for an improved optical pickup device using auxiliary photo detectors to minimize DC offsets generated by cross-talk in focus error signals caused by rapidly changing beam sizes in an optical pickup employing three beams.

### SUMMARY OF THE INVENTION

An aspect of the present invention is to solve at least the above problems and/or disadvantages and to provide at least the advantages described below. Accordingly, an aspect of the present invention is to provide an optical pickup device and a focusing control method thereof which are capable of determining a DC offset caused by cross-talk of a focus error signal and performing elimination of the DC offset based on the determination to minimize the DC offset.

It is another aspect of the invention to provide an optical pickup device and a focusing control method thereof which are capable of correcting errors in a focus error signal of a main beam, which is caused by interference of side beams, such that a optimal focus tracking can be performed.

In accordance with the embodiments of the invention, the above and/or other aspects can be achieved by the provision of an optical pickup device comprising at least one or more light sources, a diffraction optical element which diffracts light from the light source into a plurality of beams, an objective lens which condenses the plurality of beams diffracted by the diffraction optical element, a photo detector which detects the plurality of beams reflected from discs, and an auxiliary photo detector which detects the plurality of beams reflected from the discs to perform error correction of focus error detection signals obtained by the photo detector.

Preferably, the photo detector may includes a main photo detector, and first and second side photo detectors, which are located at both ends of the main photo detector.

Preferably, the main photo detector, and the first and second side photo detectors each are formed as a four-split structure.

Preferably, the auxiliary photo detector may be located at one end of the photo detector, in which the one end of the photo detector is located in a position in which the plurality of beams are not diffracted.

Preferably, the auxiliary photo detector may be located at one end of the main photo detector and the first and second side photo detector.

Preferably, the auxiliary photo detector and the one end of the main photo detector and the first and second side photo detector is spaced apart therebetween a predetermined distance, the predetermined distance being the same as a distance between the main photo detector and the first or the second side photo detector.

Preferably, the plurality of beams includes a main beam, a first sub-beam and a second sub-beam.

Preferably, the error correction of focus error detection signals is performed by subtracting twice the amount of light detected by the auxiliary photo detector from a focus error detection signal, if the auxiliary photo detector is located at one end of the first and second side photo detectors, in which the focus error detection signal is obtained from the amount of light detected by the photo detectors.

Preferably, the error correction of a focus error detection signal is performed by subtracting the amount of light detected by the auxiliary photo detector, multiplied by a predetermined constant, from the focus error detection signal, if the auxiliary photo detector is located at one end of the main photo detector, in which the focus error detection signal is obtained from the amount of light detected by the photo detectors.

In accordance with an aspect of the invention, there is provided a focusing control method of an optical pickup device comprises the steps of splitting light from a light source into a main beam, and first and second sub beams, irradiating the main beam, and the first and second sub beams to discs via a photo detector and auxiliary photo detectors, detecting the main beam, and the first and second sub beams reflected from the discs, and performing error correction of a focus error detection signal of the photo detector using the amount of light detected by the auxiliary photo detectors.

Preferably, the photo detector includes a main photo detector, and first and second side photo detectors, which are located at both ends of the main photo detector.

Preferably, the auxiliary photo detector is located at one end of the main photo detector and the first and second side photo detector.

Preferably, the auxiliary photo detector and the one end of the main photo detector and the first and second side photo detector is spaced apart therebetween a predetermined distance, the predetermined distance being the same as a distance between the main photo detector and the first or the second side photo detector.

Preferably, the error correction of focus error detection signals is performed by subtracting twice the amount of light detected by the auxiliary photo detector from focus error detection signal, if the auxiliary photo detector is located at one end of the first and second side photo detectors, in which the focus error detection signal is obtained from the amount of light detected by the photo detectors.

Preferably, the error correction of focus error detection signal is performed by subtracting the amount of light detected by the auxiliary photo detector, multiplied by a predetermined constant, from the focus error detection signal, if the auxiliary photo detector is located at one end of the main photo detector, in which the focus error detection signal is obtained from the amount of light detected by the photo detectors.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, and features, and advantages of certain embodiments of the present invention will be more apparent from the following description taken in conjunction with the accompanying drawings, in which:

FIG. 1 is a view illustrating beam shapes based on generation of focusing signals;

FIGS. 2a and 2b are views illustrating conventional beam patterns detected by photo detectors;

FIG. 3 is a view of focus error signals according to the beam patterns of FIGS. 2a and 2b, respectively;

FIG. 4 is a view illustrating an optical pickup device according to an exemplary embodiment of the present invention;

FIG. 5 is a view illustrating a photo detector according to an exemplary embodiment of the present invention; and

FIGS. 6a and 6b are views describing detection of focus error signals using the photo detector of FIG. 5.

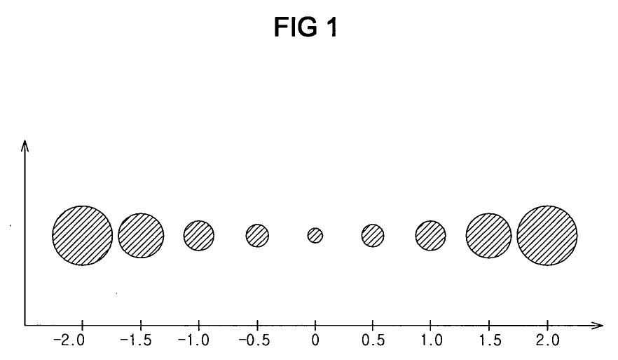

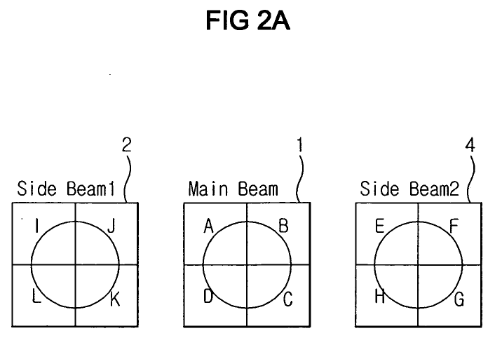

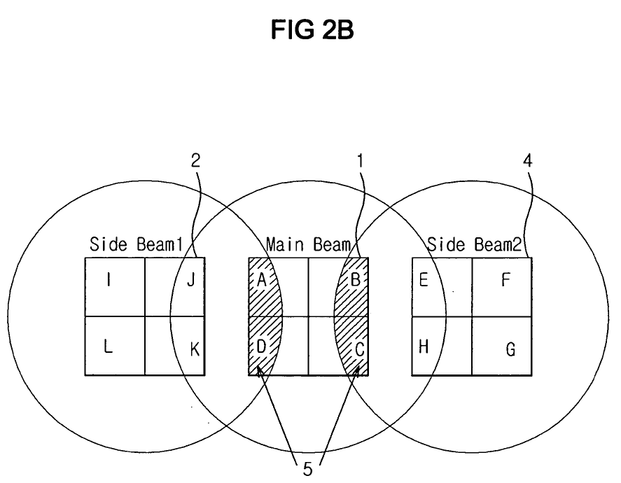

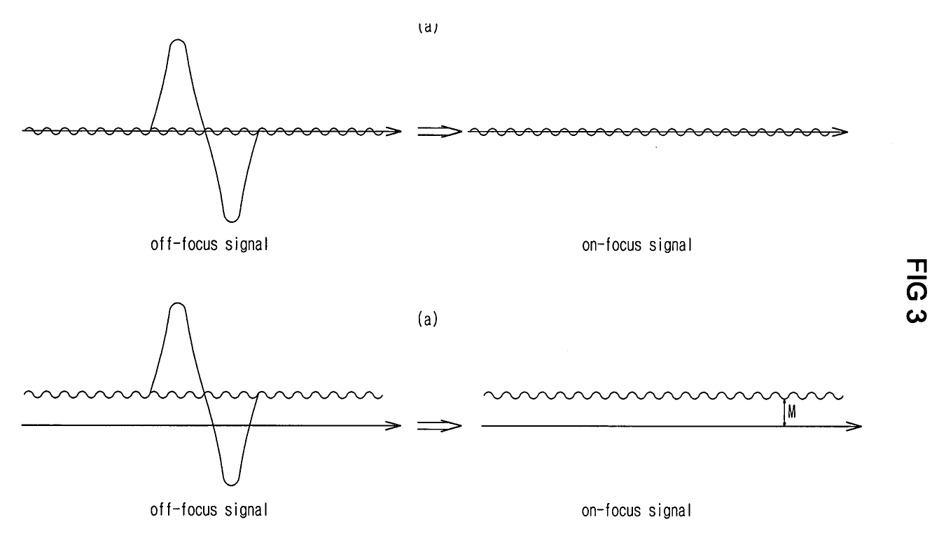

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

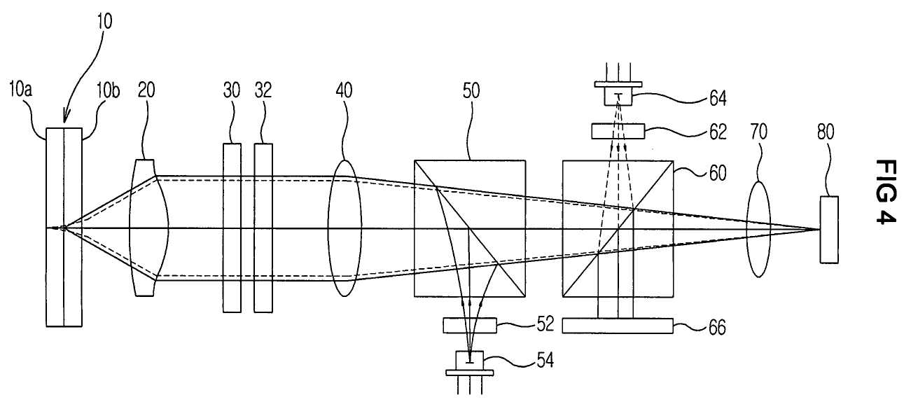

FIG. 4 is a view illustrating an optical pickup device according to an exemplary embodiment of the present invention, in which the optical pickup device can use first and second optical discs 10a and 10b having thicknesses which are different from one another. The optical pickup device includes a first light source 54 and a second light source 64 whose radiation wavelengths are different from one another. For example, the first light source 54 may be implemented with a laser diode emitting about 650 nm light and the second light source 65 may be implemented with a laser diode emitting about 780 nm light.

The lights emitted from the first and second light sources 54 and 64 are correspondingly applied to the first and second optical discs 10a and 10b. Here, the first optical disc 10a is a series of DVD optical discs, and the second optical disc 10b is a series of CD optical discs. More specifically, the emitted light from the first light source 54 is applied to the first optical disc 10a through a first cubic beam splitter 50 as an optical path converter for performing light transmission and reflection. The first cubic beam splitter 50 is located at an optical path between the first light source 54 and the first optical disc 10a. Namely, the first cubic beam splitter 50 is coated to perform transmission of more than 95% of the emitted light of the first light source 54 and to perform transmission and reflection of a predetermined percentage for the emitted light of the second light source 64. Also, the emitted light from the second light sources 64 is applied to the second optical disc 10b through a second cubic beam splitter 60 as an optical path converter for performing light transmission and reflection. The second cubic beam splitter 60 is located at an optical path between the second light source 64 and the second optical disc 10b. Namely, the second cubic beam splitter is coated to perform transmission of more than 95% of the emitted light of the second light source 64 and to perform transmission and reflection of a predetermined percentage for the emitted light of the first light source 54. Here, the first and second cubic beam splitters 50 and 60 are manufactured to be adapted to the first and second optical discs 10a and 10b, respectively.

Also, the optical pickup device includes a collimating lens 40 for collimating beams which are outputted from the first and second light sources 54 and 64 and pass through the first and second cubic beam splitters 50 and 60, a ¼ polarizer 32 for converting P- or S-polarized light into circular polarized light, a Hologram grating 30 for reproducing signals in a DVD-RAM and DVD-R/RW as a polarization hologram element, and an objective lens 20 for condensing lights in the first and second optical discs 10a and 10b.

The optical pickup device includes a photo detector 80 for receiving lights reflected from the first and second optics 54 and 64 through the optical elements aligned on the respective optical paths and supporting implementation of a focusing servo and a tracking servo. Also, it further includes a front monitor photo detector 66 for detecting light reflected from the first optical disc 10a.

The optical pickup device includes a first grating 52 between the first light source 54 and the first cubic beam splitter 50. A second grating 62 is arranged between the second light source 64 and the second cubic beam splitter 60. Here, the first and the second gratings 52 and 62 diffract beams from the first and second light sources 54 and 64 into three beams, respectively. Even though the exemplary embodiment of the present invention is implemented such that the respective first and the second light sources 54 and 64 are separated from the respective first and the second gratings 52 and 62, they can be configured to be a single module, respectively.

The optical pickup device includes an astigmatism lens 70 or a concave lens on an optical path between the second cubic beam splitter 60 and the photo detector 80, in which the astigmatism lens 70 generates a astigmatism on incident light. Here, the astigmatism of the astigmatism lens 70 is used for focusing error detection by an astigmatism method.

As such, the light emitted from the first light source 54 is split into three beams through the first grating 52. The three beams are transmitted and reflected by the first cubic beam splitter 50. One of the beams from the first cubic beam splitter travels to the first optical disc 10a. After that, the light reflected from the first optical disc 10a travels to the photo detector 80 through the first and second cubic beam splitters 50 and 60. Similarly, the light emitted from the second light source 64 is also split into three beams through the second grating 62. These three beams are transmitted and reflected by the second cubic beam splitter 50. One of the beams from the second cubic beam splitter 600 travels to the second optical disc 10b. After that, the light reflected from the second optical disc 10a travels to the photo detector 80 through the first and second cubic beam splitters 50 and 60.

The lights received by the photo detector 80 are used for a focusing servo and a tracking servo. Here, the photo detector 80 is shared by the first and second light sources 54 and 64.

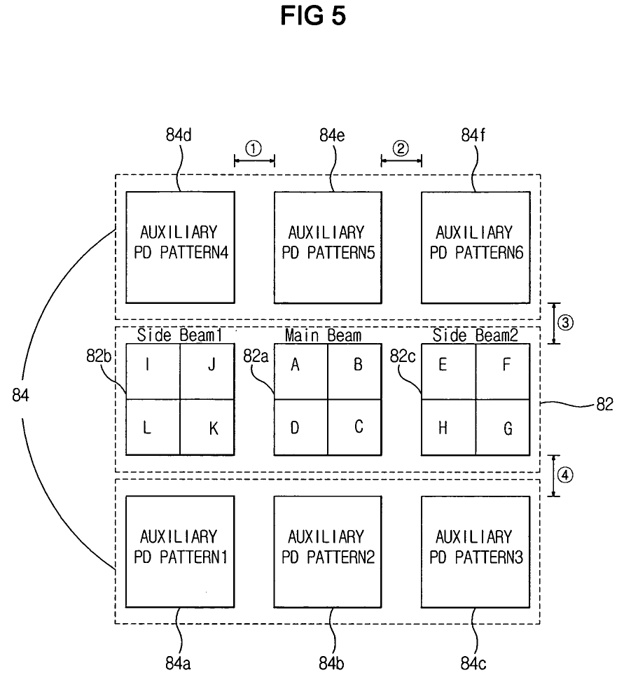

As shown in FIG. 5, the photo detector 80 includes a primary photo detection unit 82 and auxiliary photo detection units 84 aligned at both ends of the primary photo detection unit 82. The primary photo detection unit 82 includes a main photo detector 82a, which is a four-split structure, and side photo detectors 82b and 82c which are aligned at both ends of the main photo detector 82a. Each side photo detector 82b and 82c are of a four-split structure. As a result, the primary photo detection unit 82 is a 12-split structure. Therefore, light received by the primary photo detection unit 82 is used in a difference astigmatism method to acquire a focusing error detection signal FES, which is expressed by the following equation (1).
FES1=[(A+C)−(B+D)]+G[((E+G)+(I+K))−((F+H)+(J+L))] (1)

Here, G denotes a gain applied to detection signals of the side photo detectors 82b and 82c. Namely, since the amount of lights from the side photo detectors 82b and 82c are relatively smaller than that of the main photo detector 82a, the gain is applied to the detection signals of the side photo detectors 82b and 82c, such that an optimal focus error signal can be detected.

On the other hand, as shown in FIG. 5, the auxiliary photo detection units 84, aligned at both end of the primary photo detection unit 82, include two sets, one of which has three auxiliary photo detectors, 84a, 84b and 84c, and another of which has three auxiliary photo detectors, 84d, 84e and 84f. Namely, the auxiliary photo detectors 84b and 84e in the auxiliary photo detection units 84 are located at both ends of the main photo detector 82a. Also, the auxiliary photo detectors 84a and 84d, and 84c and 84f in the auxiliary photo detection units 84 are located at both ends of each of the side photo detectors 82b and 82c. Here, the photo detector 80 is designed such that distances, indicated by circled numerals 3 and 4 in FIG. 5, between the respective auxiliary photo detection units 84 and the primary photo detection unit 82 are the same as the distances, indicated by circled numerals 1 and 2 in FIG. 5, between the main photo detector 82a and the respective auxiliary photo detectors 82b and 82c. Also, the photo detector 80 is designed such that each size of all of the auxiliary photo detectors 84a to 84f is the same as that of the main photo detector 82a and the auxiliary photo detectors 82b and 82c. In the exemplary embodiment, the photo detector 80 is implemented such that the six auxiliary photo detectors 84a to 84f are installed, however, other suitable arrangements of auxiliary photo detectors 84a to 84f may be used. Namely, any suitable number of the auxiliary photo detector 84a to 84f may be used so that DC offset of the focusing error detection signals is minimized.

When a focusing error detection signal is obtained using equation (1), first and second side beams of the three beams (a main beam and two side beams), which are reflected from the first or second optical discs 10a and 10b and then received by the primary photo detection unit 82 of the photo detector 80, may be incident upon the main photo detector 82a, thereby causing interference in the main beam. As a result, a DC offset is generated by cross talk in the focus error detection signal; however, the crosstalk can be eliminated based on the amount of lights detected by the auxiliary photo detection units 84.

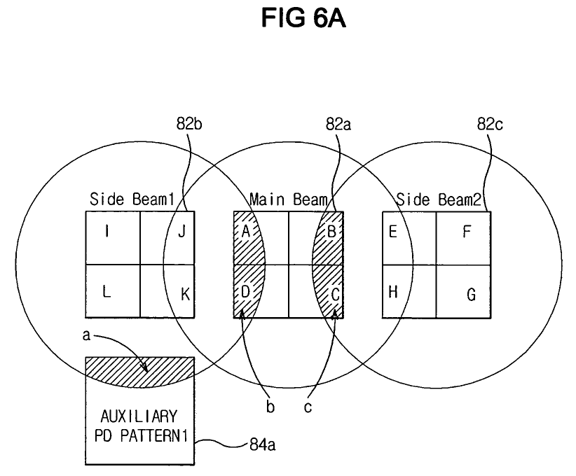

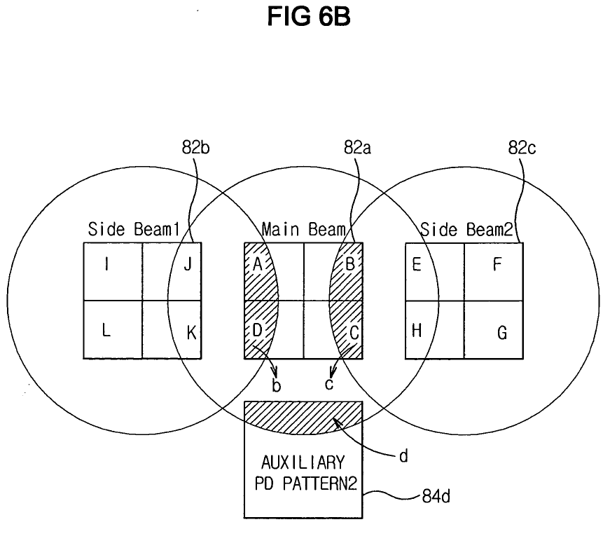

As shown in FIG. 6a, when the first auxiliary photo detector 84a is employed at one end of the first side detector 82b, a method for correcting a DC offset of a focus error detection signal is described in detail below. If a part of the side beam is received in the main photo detector 82a, which receives the main beam according to its beam size variation, interference is caused by the side beams generated in the main beam, by an area A and D, and an area B and C, corresponding the amount of lights b and c, respectively. On the other hand, if the amount of light received by the first auxiliary photo detector 84a is the same as the amount of light b causing interference in the main photo detector 82a, because the distance between the first auxiliary photo detector 84a and the first side photo detector 82b is the same as that between the first side photo detector 82b and the main photo detector 82a, the total DC offset by (b+c) in the main photo detector 82a is twice the amount of light received by the first auxiliary photo detector 84a. Therefore, based on the detection of the DC offset as mentioned above, error correction of the focus error detection signal of light received by the primary photo detection unit 82 can be performed by following equation (2).
FES2=FES1-2a (2)

As error correction of the focus error detection signal based on equation (2) is performed in a situation wherein the first auxiliary photo detector 84a is operated in the auxiliary photo detection unit 84, it can also be identically applied to a situation wherein one of the auxiliary photo detectors 84c, 84d, and 84f is operated in the auxiliary photo detection unit 84.

As shown in FIG. 6b, when the second photo detector 84b is employed at one end of the main photo detector 82a, a method for correcting a DC offset of a focus error detection signal is described in detail below. If a part of the side beam is received in the main photo detector 82a, interference occurs in an area A and D and an area B and C corresponding to the amount of lights b and c, respectively. On the other hand, the area corresponding to the amount of light d received by the second auxiliary photo detector 84b is the same as the area corresponding to the amount of light b, which causes interference in the main photo detector 84a, because the distance between the second auxiliary photo detector 84b and the main photo detector 82a is the same as the distance between the first side photo detector 82b and the main photo detector 82b. On the other hand, the amount of light d received by the second auxiliary photo detector 84b is the same as the amount of the light is caused by the main beam, and at this time interference by the side beams occurs in the main photo detector 82a. As mentioned above, the amount of light received by the main photo detector 82a is G times the amount of lights received by the side photo detectors 82b and 82c. As a result, the amount of light d in the second auxiliary photo detector 84b is larger by G times the amount of light b corresponding to an area causing interference in the main photo detector 82a. Namely, the total DC offset by (b+c) in the main photo detector 82a is [(1/G)×2] times the amount of light d received by the second auxiliary photo detector 84b. Therefore, based on the detection of the DC offset as mentioned above, error correction of the focus error detection signal of light received by the primary photo detection unit 82 can be performed by the following equation (3).
FES3=FES1−(2d/G) (3)

As error correction of the focus error detection signal based on equation (3) is performed in the situation wherein the second auxiliary photo detector 84c is operated in the auxiliary photo detection unit 84, it can also be identically applied to a situation wherein the fifth auxiliary photo detector 84e is operated in the auxiliary photo detection unit 84.

As such, when the side beams in the main photo detector generate interference, errors can be corrected based on determination that quantity of DC offset of focus error detection signals is detected by using the auxiliary photo detectors.

The optical pickup device and the focusing control method thereof according to the exemplary embodiment of the present invention can minimize DC offsets generated in the cross-talk of focus error signals caused by rapidly changing beam sizes in an optical pickup employing three beams, using auxiliary photo detectors.

Also, the optical pickup device and the focusing control method thereof according to the exemplary embodiment of the present invention can optimize positions of auxiliary photo detectors considering positions of the main and the side photo detectors, and correct errors according to DC offsets of focus error detection signals using a simple equation, such that signal processing can be easily performed.

The optical pickup device and the focusing control method thereof according to the exemplary embodiment of the present invention can optimize focus error detection signals using the auxiliary photo detectors, such that performance of the optical pickup device can be enhanced.

While the invention has been shown and described with reference to certain embodiments thereof, it will be understood by those skilled in the art that various changes in form and details may be made therein without departing from the spirit and scope of the invention as defined by the appended claims.

1. An optical pickup device comprising:
at least one or more light sources;
a diffraction optical element which diffracts light from the light sources into a plurality of beams;
an objective lens which condenses the plurality of beams diffracted by the diffraction optical element on a disc;
a photo detector which detects the plurality of beams reflected from discs; and
an auxiliary photo detector which detects the plurality of beams reflected from the discs to perform error correction of focus error detection signals obtained by the photo detector.

2. The optical pickup device as set forth in claim 1, wherein the photo detector includes a main photo detector, and first and second side photo detectors, which are located at both ends of the main photo detector.

3. The optical pickup device as set forth in claim 2, wherein the main photo detector, and the first and second side photo detectors each are formed as a four-split structure.

4. The optical pickup device as set forth in claim 1, wherein the auxiliary photo detector is located at one end of the photo detector, in which the one end of the photo detector is located in a position at which the plurality of beams are not diffracted.

5. The optical pickup device as set forth in claim 2, wherein the auxiliary photo detector is located at one end of the main photo detector and the first and second side photo detector.

6. The optical pickup device as set forth in claim 5, wherein the auxiliary photo detector and the one end of the main photo detector and the first and second side photo detector are spaced apart therebetween a predetermined distance, and the predetermined distance is the same as a distance between the main photo detector and the first or the second side photo detector.

7. The optical pickup device as set forth in claim 6, wherein the plurality of beams includes a main beam, a first sub-beam and a second sub-beam.

8. The optical pickup device as set forth in claim 7, wherein the error correction of focus error detection signals is performed by subtracting twice the amount of light detected by the auxiliary photo detector from a focus error detection signal, if the auxiliary photo detector is located at one end of the first and second side photo detectors, in which the focus error detection signal is obtained from the amount of light detected by the photo detectors.

9. The optical pickup device as set forth in claim 7, wherein the error correction of a focus error detection signal is performed by subtracting the amount of light detected by the auxiliary photo detector, multiplied by a predetermined constant, from the focus error detection signal, if the auxiliary photo detector is located at one end of the main photo detector, in which the focus error detection signal is obtained from the amount of light detected by the photo detectors.

10. The optical pickup device as set forth in claim 9, wherein the predetermined constant is expressed by the following equation
constant=(amount of first or second sub beam/amount of main beam)/2.

11. The optical pickup device as set forth in claim 7, wherein the error correction of focus error detection signal is performed based on focus error detection signal of the main beam.

12. A focusing control method of an optical pickup device comprising the steps of:
splitting light from a light source into a main beam, and first and second sub beams;
irradiating the main beam, and the first and second sub beams to discs via a photo detector and auxiliary photo detectors;
detecting the main beam, and the first and second sub beams reflected from the discs; and
performing error correction of a focus error detection signal of the photo detector using the amount of light detected by the auxiliary photo detectors.

13. The method as set forth in claim 12, wherein the photo detector includes a main photo detector, and first and second side photo detectors, which are located at both ends of the main photo detector.

14. The method as set forth in claim 13, wherein the auxiliary photo detector is located at one end of the main photo detector and the first and second side photo detector.

15. The method as set forth in claim 14, wherein the auxiliary photo detector and the one end of the main photo detector and the first and second side photo detector is spaced apart therebetween a predetermined distance, and the predetermined distance is the same as a distance between the main photo detector and the first or the second side photo detector.

16. The method as set forth in claim 15, wherein the error correction of focus error detection signals is performed by subtracting twice the amount of light detected by the auxiliary photo detector from focus error detection signal, if the auxiliary photo detector is located at one end of the first and second side photo detectors, in which the focus error detection signal is obtained from the amount of light detected by the photo detectors.

17. The method as set forth in claim 15, wherein the error correction of focus error detection signal is performed by subtracting the amount of light detected by the auxiliary photo detector, multiplied by a predetermined constant, from the focus error detection signal, if the auxiliary photo detector is located at one end of the main photo detector, in which the focus error detection signal is obtained from the amount of light detected by the photo detectors.

18. The method as set forth in claim 17, wherein the predetermined constant is expressed by the following equation
constant=(amount of first or second sub beam/amount of main beam)/2.
